(19) United States
(12) Patent Application Publication
(10) Pub. No.: US 2026/0132003 A1
(43) Pub. Date: May 14, 2026

(54) Jack with Self-Adjusting Securement Mechanism

(71) Applicant: Powernail Company, Genoa City, WI (US)

(72) Inventor: Todd J. Anstett, Island Lake, IL (US)

(73) Assignee: Powernail Company, Genoa City, WI (US)

(21) Appl. No.: 18/946,544

(22) Filed: Nov. 13, 2024

(51) Int. Cl. B66F 3/06

(52) U.S. Cl. CPC B66F 3/06; B66F 2700/03

(57) ABSTRACT

Jacks capable of exerting force against building components and other objects are disclosed. The jacks are provided with a self-adjusting securement mechanism capable of securing the jack to different support members that have a range of different thickness dimensions so as to hold the jack in position to exert the force. The securement mechanism secures the jack to a support member so that the force can be exerted. The jacks may have a base, a ram, a ram drive mechanism, and a securement mechanism for securing and clamping the jack to a support member. The ram and ram-drive mechanism are supported on the base with the ram being extendable by the ram-drive mechanism to apply a pushing force. The securement mechanism may include a pair of independently pivotable jaws with gripping surfaces. Each jaw is eccentrically pivotably mounted along a second side of the base on a pivot axis approximately equidistant from the base axis. Each jaw is biased to pivot so as to swing each gripping surface toward the other, thereby self-adjusting the jaws to the thickness of a support member when between the jaws and securing the jack to the support member as the pushing force is applied by the jack. The securement mechanism is capable of quick release from the support member to allow for easy removal or repositioning of the jack.

### FIELD

The field relates to tools for performing work on buildings and other things and, more specifically, to jacks for applying force to a component.

### BACKGROUND

Jacks are a type of tool used by carpenters and those in the building and construction trades to apply force for the purpose of moving components of many different types. In the building and construction field, the types of building components which can be acted on and moved with a jack can include flooring planks, flooring strips, subfloor panels, flooring tiles, wall panels, joists, studs, and other building components. For example, a jack may be used to push adjacent planks or panels tightly together, or against a surface such as a wall or cabinet, so that the carpenter can nail or otherwise secure the components together and/or to a building support member such as a joist, a subfloor, or some other support. The force applied by the jack is useful to ensure that the building components fit snugly together with a uniform appearance. Depending on the circumstances, uniformity of appearance could mean, for example, consistent gaps between building components, or no gaps or spaces between building components, or simply a uniformity of appearance of the building components, such as by removing warping.

A jack must be firmly secured in place in order to apply a pushing force directly or indirectly to a building component. Securement of the jack in a stationary position allows a ram to extend and to push against a building component.

One approach to securement of a jack is to provide the jack with a securement mechanism which attaches the jack to a joist. For example, the jacks described in U.S. Patent Nos. 822,093 (Wyer) and 3,143,335 (Lassahn), and in U.K. Patent Nos. 18,694 (Wyer) and 27,669 (Thompson) utilize a single jaw or two jaws which grip a joist on which the jack is positioned. However, the jacks described in these patents are disadvantageous at least because the user is required to manually adjust the jaws against the joist with the user’s free hand by means of a linkage, or a lever, or even directly with the user’s fingers. The need for manual adjustment of the securement mechanism is disadvantageous at least because the user’s free hand could be better used to operate the jack and because it is desirable to keep the user’s hand clear of the securement mechanism as force is applied by the jack.

Other examples of jacks intended to be secured to a joist are described in U.S. Patent Nos. 6,616,132 (Ellison) and 5,660,372 (Bobel). These jacks rely on securement mechanisms with either sliding teeth or with feet offset from the ram, both of which can slip as the jack applies force and which inconveniently require the user’s free hand to hold the jack until the securement mechanism engages the joist.

It would be an advance in the art to provide a jack with a self-adjusting securement mechanism wherein the jack is capable of directly or indirectly applying a force against a building component, such as flooring planks, wherein the jack would be capable of rapid and immediate securement to a support member such as a joist or board, wherein the jack would be capable of securement to support members of different thicknesses, wherein the jack could be secured to the support member without any need to manually adjust the securement mechanism with the user’s free hand, wherein the jack would be positively secured to the support member as force applied by the jack increases, wherein the jack could be quickly and immediately repositioned on the support member or removed from the support member after application of the force, and which would generally improve the quality and efficiency of work capable of being performed by professionals in the building and construction trades for tasks such as flooring, panel, and building component installation.

### SUMMARY

The present invention relates to improved jacks provided with a self-adjusting securement mechanism. Jacks as described herein may be used to apply a force against an object or article such as a building component. The securement mechanism is capable of automatically adjusting to a thickness dimension of a support member to secure the jack with respect to the support member so that the jack can apply the force. The automatic adjustment of the securement mechanism holding the jack in place on the support member may be accomplished without use of a lever or a linkage connected directly to the securement mechanism and without adjustment by means of the user’s fingers.

In embodiments, a jack may include a base, a ram, a ram-drive mechanism, and a securement mechanism. The base may support the ram, the ram-drive mechanism, and the securement mechanism. The base may have first and second sides and have a length which defines an axis. The ram may be extendable from the first side of the base along the axis of the base and the ram-drive mechanism may be in power-transmission relationship with the ram, thereby enabling the ram to extend to apply a pushing force.

The securement mechanism is provided to secure the jack to a support member so that the ram-drive mechanism can extend the ram to apply a force. In embodiments, the securement mechanism may have a pair of independently pivotable jaws with gripping surfaces. The gripping surfaces may generally face inwardly and toward each other. Each jaw may be eccentrically pivotably mounted along the second side of the base on a pivot axis approximately equidistant from the axis of the base. Each jaw may be biased to pivot to swing each gripping surface toward the other. Such jaws self-adjust to the thickness of a support member when the support member is between the jaws, providing the capability to use the jack with support members of different thicknesses. The jaws are capable of applying a clamping-type force which secures the jack to the support member as the pushing force is applied by the jack to hold the jack in place.

In embodiments, each jaw is capable of pivoting independently of the other and each jaw can pivot toward the other until stopped by contact with a support member therebetween. Also in embodiments, each jaw may be a type of cam. Pivoting movement of the jaws toward each other as force is applied by the jack reduces the spacing between the lobes of each jaw, resulting in application of force which holds the jack firmly to the support member. Each jaw may further include structure which improves holding of the jaw, and thus the jack, against the support member. For example, the gripping surfaces of the jaws may be curved to provide for contact with support members of different thicknesses. Each gripping surface may include a plurality of projections, such as teeth, to provide a more positive grip against the support member. The clamping force applied by the jaws against the support member may increase as the pushing force applied by the jack increases.

In embodiments, the ram driven by the ram-drive mechanism may comprise a bar having a distal end and a pusher attached to the bar distal end. The ram-drive mechanism may comprise a rack along the bar and a pinion gear meshed with the rack, which enable a lever to power pinion gear rotation to extend the ram. Operation of the lever in a rearward direction may extend the ram as the pinion gear drives the rack. A ratchet mechanism including one or more anti-reversing pawl and pinion gear may be provided. When engaged, the pawl may limit reverse rotation of the pinion gear to maintain the force applied by the jack. When the pawl is disengaged, the force may be released allowing repositioning of the jack for additional pushing cycles.

Other features and embodiments are described in the drawings and detailed description which follows.

### BRIEF DESCRIPTION OF THE DRAWINGS

Examples of jacks with a self-adjusting securement mechanism may be understood by reference to the following description taken in conjunction with the accompanying drawings, in which like reference numerals identify like elements throughout the different views. The drawings are not necessarily to scale, emphasis instead being placed upon illustrating the principles of the invention.

In the accompanying drawings:

FIG. 1 is an isometric view of a jack with a self-adjusting securement mechanism according to the invention;

FIG. 2 is a further isometric view of the jack of FIG. 1 shown atop a support member and pushing a plank;

FIG. 3 is a side elevation view of the jack of FIG. 1 shown atop a support member and pushing a plank;

FIG. 4 is an isometric view showing a first side of the jack of FIG. 1;

FIG. 5 is a plan view of a second side of the jack of FIG. 1;

FIG. 6 is a plan view of the first side of the jack of FIG. 1;

FIG. 7 is an exploded view of the jaws implemented with the jack of FIG. 1;

FIGS. 8-10 are isometric and plan views of a jaw implemented with the jack of FIG. 1;

FIG. 11 is a section view of the jack taken along Section 11-11 of FIG. 5;

FIG. 12 is a section view of the jack taken along Section 11-11 of FIG. 5, but showing extension of the ram;

FIG. 13 is a section view of the jack taken along Section 11-11 of FIG. 5, but showing release of force applied by the ram; and

FIGS. 14-15 are plan views of the jack of FIG. 1 illustrating self-adjusting securement of the jack to support members of different thickness dimensions.

### DETAILED DESCRIPTION

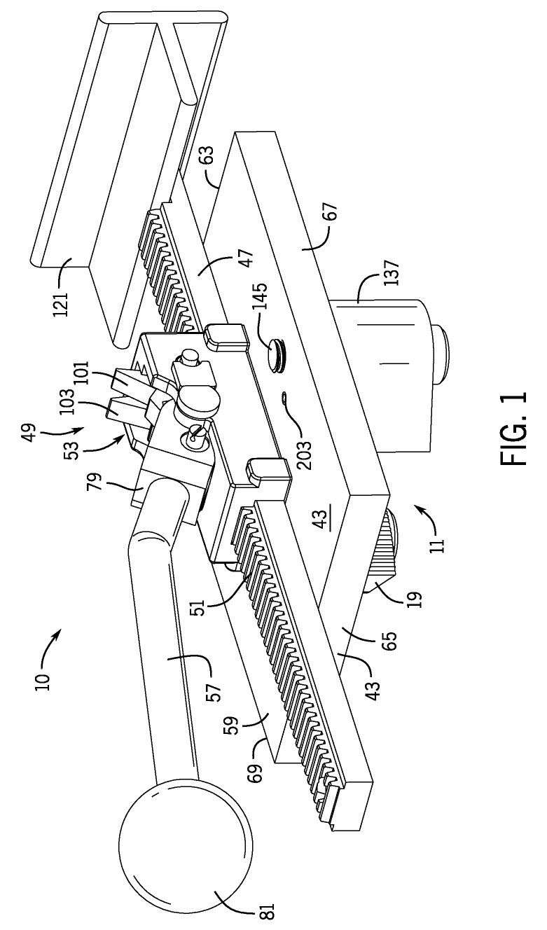

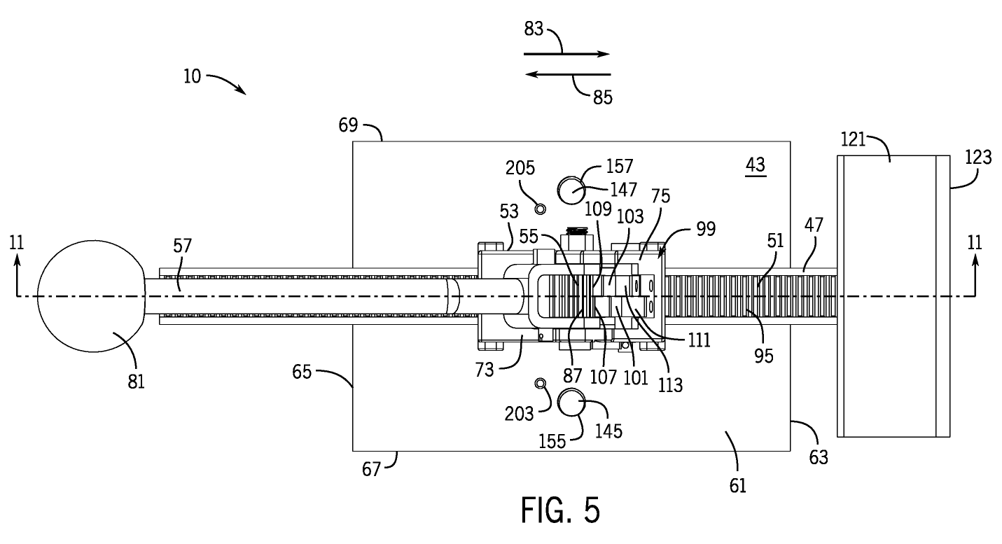

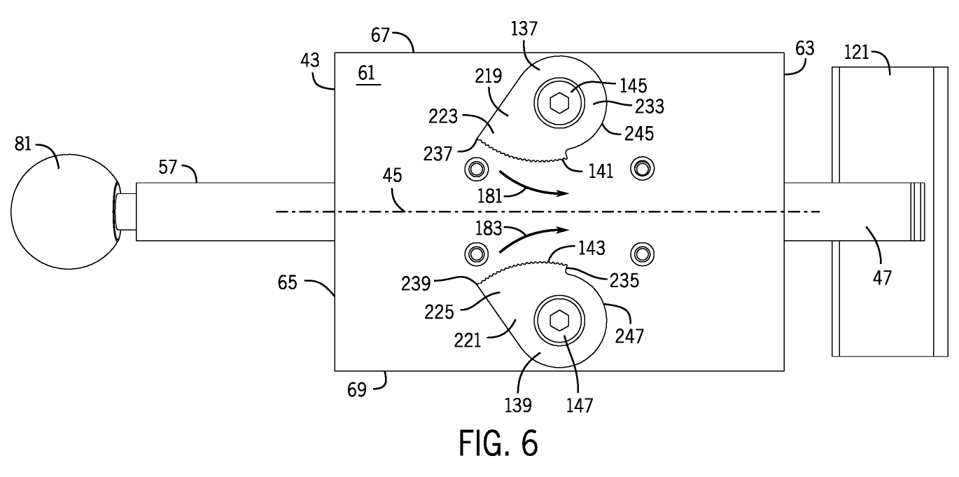

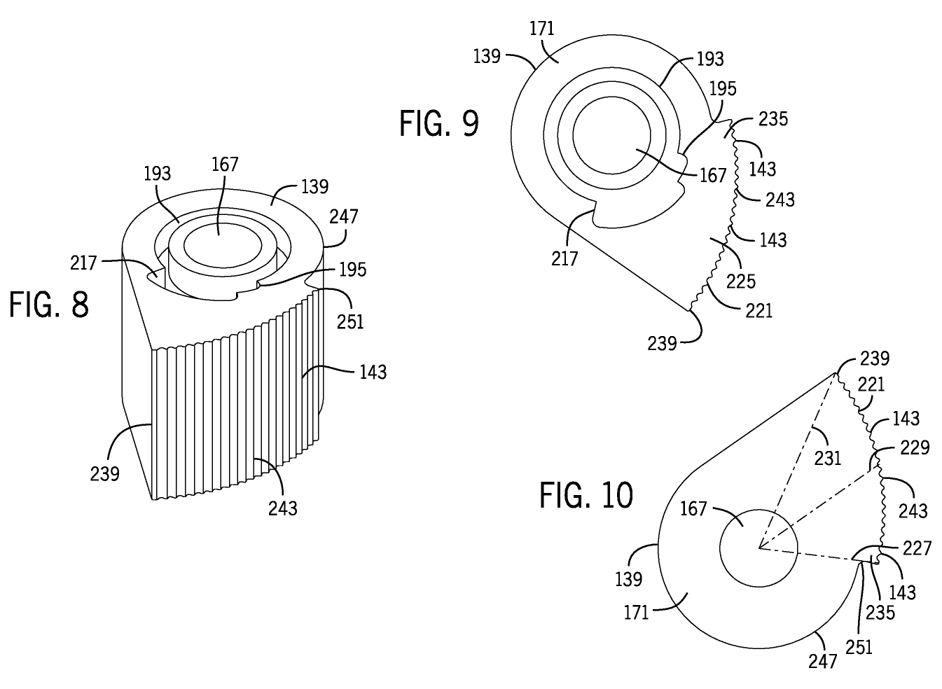

As illustrated in FIGS. 1-15, the present invention relates to an improved jack 10 with a self-adjusting securement mechanism 11. The securement mechanism 11 is capable of securing jack 10 to a support member 13 such as a joist, a stringer, a stair riser, a wall stud, a beam, or any like structure to which jack 10 can be secured. Once secured to support member 13, jack 10 can apply a pushing force against another object or thing near the jack 10.

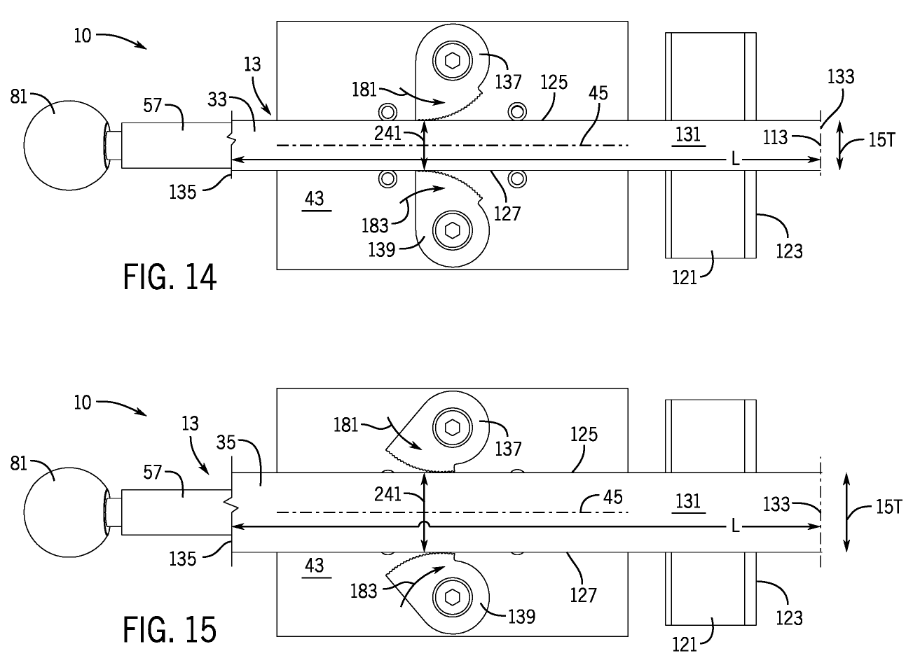

A novel aspect of jack 10 is that securement mechanism 11 is capable of automatic self-adjustment to a range of different support member 13 thickness dimensions 15 or “T”. This automatic self-adjustment capability enables jack 10 to be quickly secured with respect to a range of support members 13 having different thickness dimensions 15 for application of force by jack 10. FIGS. 14-15 illustrate examples of a jack 10 embodiment secured with respect to support members 13 having different thickness dimensions 15. A further novel aspect of jack 10 is that securement mechanism 11 is capable of rapid desecurement from a support member 13 following application of the force. Securement mechanism 11 enables the user to rapidly and efficiently position and reposition jack 10 for each use.

The automatic self-adjustment of securement mechanism 11 with respect to support member 13 avoids any need for manual securement of jack 10 to support member 13 by the user, such as by means of levers, linkages, or adjustment with the user’s hand and fingers. Further, the temporary securement of jack 10 to support member 13 by securement mechanism 11 avoids any need to use nails, screws, or other types of fasteners to secure jack 10 to support member 13, meaning that jack 10 can be quickly positioned and repositioned for use.

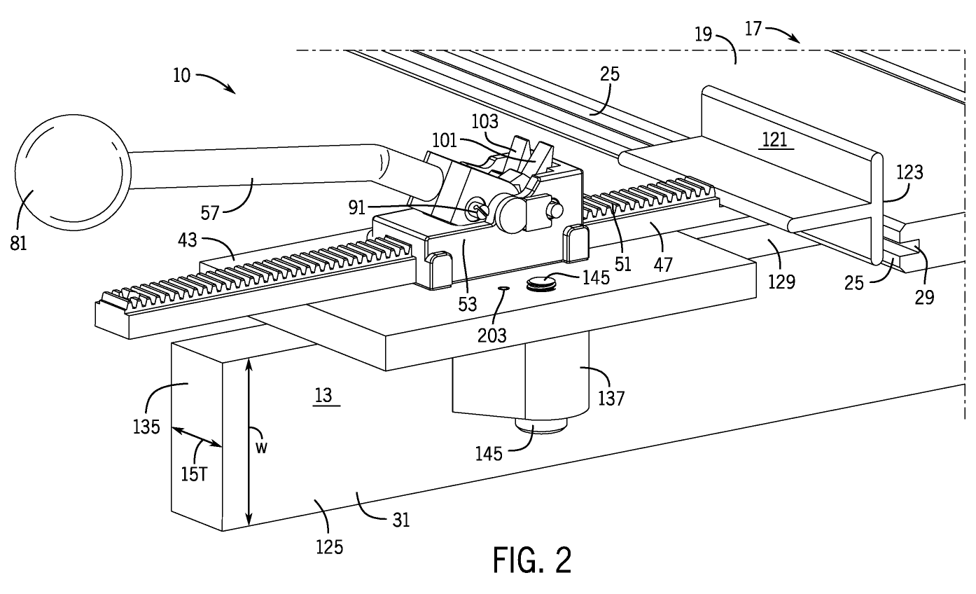

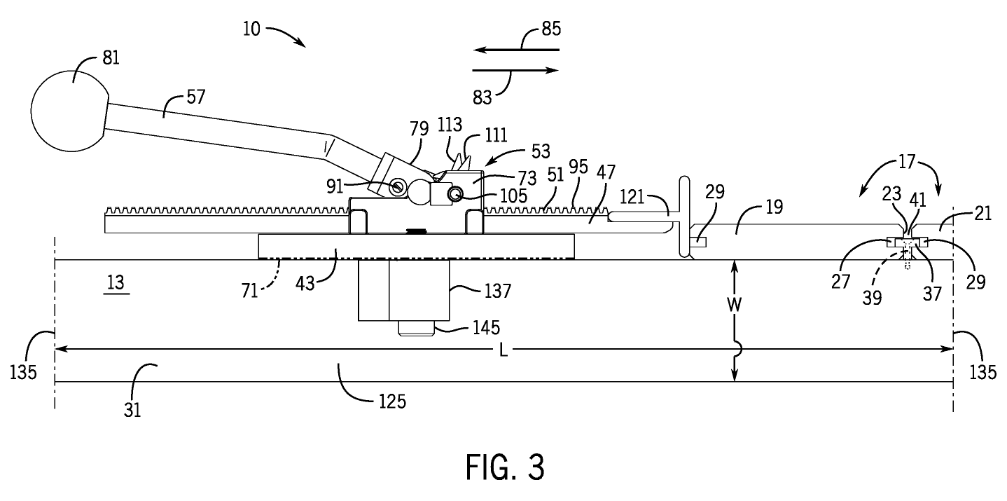

Referring further to FIGS. 1-15, jack 10 is a type of implement, or tool, designed to exert a force against another object or thing. In the building and construction field, the force applied by jack 10 may be applied directly or indirectly against a building component 17 such as the planks 19, 21 illustrated in FIGS. 2-3, or other building components 17 such as flooring strips, tiles, subfloor panels, wall panels, roof decks, joists, and studs (not shown). The force may be used to urge a building component 17 into the desired position with respect to the building. In some applications, the force may be used to straighten warped or uneven building components 17 to avoid unwanted inconsistent gaps or abutment between adjacent building components 17.

One of many potential uses for jack 10 is in connection with installation of a deck or floor made up of a plurality of planks or flooring strips, such as planks 19 and 21 illustrated in FIGS. 2-3. Planks 19, 21 making up such an exemplary deck or floor could be of any material, such as a plastic composite material, a laminate, or wood and may be of any length, width, and thickness. In the examples of FIGS. 2-3, planks 19, 21 are shown in the form of composite plastic planks with edge sides 23, 25 including a groove 27, 29 formed therein. In other applications, planks 19, 21 may have edge sides 23, 25 that are flat (not shown) for forming a butt joint with an adjacent plank.

In certain applications, planks 19, 21 may be placed atop a support member 13, such as a plurality of parallel deck or floor joists, such as the joists 31, 33, 35 illustrated in FIGS. 2-3 and 14-15. Planks 19, 21 may be parallel to each other and may be normal to joist 31, 33, 35 as illustrated with planks 19, 21 and joist 31 in FIGS. 2-3. Jack 10 may be used to snug planks 19, 21 toward and/or against each other.

As illustrated in FIG. 3, planks 19, 21 may be secured to joist 31 by a plurality of fasteners, one of which is indicated by reference number 37. Fastener 37 may be of a type referred to as a “hidden fastener” because fastener 37 is shielded from view by planks 19, 21. In the example, each fastener 37 fits into grooves 27, 29 of adjacent planks 19, 21. Each hidden fastener 37 may be secured to joist 31 by means of a screw, such as screw 39. Jack 10 is useful in a decking application such as this to push planks 19, 21 closely against the hidden fasteners 37 to ensure the hidden fasteners 37 extend deeply into grooves 27, 29 to thereby provide a neat and consistent appearance of planks 19, 21 with small water-drainage gaps 41 between planks 19, 21 as provided by fasteners 37. Each plank 19, 21 may be laid sequentially one after the other until the deck or floor is completed. In addition to providing for snug positioning of planks 19, 21, the force applied by jack 10 can be used to straighten planks 19, 21 which may be bowed, bent, or warped.

As a further example, jack 10 may be used in connection with positioning one or more subfloor panels (not shown). As is known, subfloor panels can be made of materials such as plywood or oriented strand board (OSB) and may be provided in large sizes such as 4’ x 8’ panels or 3’ x 5’ panels. These panels may be provided with flat abutting edge surfaces or tongue-and-groove edge surfaces.

These types of subfloor panels are heavy and may be difficult to position with edge surfaces fitting tightly together, especially if just one person is attempting to position the panels. Moreover, extra force may be required to join subfloor panels with tongue-and-groove edge structure, especially if the tongue-and-groove structure was damaged during shipment or handling. Jack 10 can be used as described above in connection with planks 19, 21 to push these types of large subfloor panels tightly together for proper installation and securement, for example, to a joist (e.g., joist 31, 33, or 35) on which the subfloor panels are supported.

An aspect of jack 10 is that securement mechanism 11 enables jack 10 to be quickly and easily repositioned on the support member 13 (e.g., joists 31, 33, or 35) as additional planks such as 19 and 21 or panels are added. In addition, jack 10 can automatically adjust to any irregularities or differences in the thickness dimension 15 which might exist in support member 13, or different support members 13, as is explained in connection with FIGS. 14 and 15.

Turning then to the examples of FIGS. 1-15, jack 10 may include a base 43 with a base axis 45, a ram 47, and a ram-drive mechanism 49 in power-transmission relationship with ram 47. Ram 47 may be in the form of a bar. Ram-drive mechanism 49 is operative to extend ram 47 from base 43 along axis 45 to exert a force directly or indirectly to a building component 17, such as planks 19, 21 or a subfloor panel (not shown) as previously described.

A preferred ram-drive mechanism 49 may include a rack-and-pinion gear arrangement. The rack-and-pinion may include a rack 51 secured coaxially to ram 47 or forming a part of ram 47 and a gear housing 53 including a pinion gear 55 which meshes with rack 51. Lever 57 may be operable to extend ram 47 from base 43 along base axis 45 by means of rack 51 and pinion gear 55 as described herein.

Base 43 may include a first side 59, a second side 61, a first end 63, a second end 65 and side edges 67, 69. In embodiments, first side 59 may be considered a top side while second side 61 may be considered a bottom side. First and second ends 63, 65 may be considered a front (i.e., forward) end and a rear (i.e., rearward) end respectively. In embodiments, second side 61 of base 43 may be a flat surface. Providing a flat surface on second side 61 can enable jack 10 to rest on a support member 13, such as the joists 31, 33, or 35 illustrated in FIGS. 2-3 and 14-15 or another support member 13. In such embodiments, second side 61 of base 43 may define a plane 71. In other embodiments, second side 61 of base 43 may be provided in configurations other than the planar or flat configuration shown.

Referring now to FIGS. 1-3, 5, and 11-12, gear housing 53 of ram-drive mechanism 49 may be secured with respect to first side 59 of base 43. Gear housing 53 may include first and second parallel side walls 73, 75 supporting shaft 77 journaled therein. Yoke 79 of lever 57 may be fixedly secured to shaft 77 connecting lever 57 and shaft 77. Pinion gear 55 may be mounted for free rotation on shaft 77. Knob 81 may be provided at an end of lever 57 to enable a user to easily grasp and swing lever 57 with the user’s hand.

Lever 57 of ram-drive mechanism 49 may be capable of a forward swinging stroke in the direction of arrow 83 and, alternatively, a rearward swinging stroke in the direction of arrow 85. Pinion gear 55 may rotate about shaft 77, alternatingly, in the forward direction indicated by arrow 83 or the rearward direction indicated by arrow 85 (i.e., clockwise or counterclockwise rotation). Pinion gear 55 may include a plurality of teeth 87 extending radially outward from pinion gear 55.

In the example, lever 57 may include a one-way clutch 89 provided to power rotation of pinion gear 55 in the rearward direction of arrow 85 to extend ram 47 while alternatively enabling forward swinging movement of lever 57 in the forward direction of arrow 83 to position lever 57 for a further stroke or to retract ram 47 to release the force applied by jack 10 as described herein. Clutch 89 may include a spring-biased pin 91 journaled in yoke 79 of lever 57. Pin 91 may include a drive surface 93 and pin 91 may be urged by a spring (not shown) so that drive surface 93 meshes with a tooth 87 of pinion gear 55 when lever 57 is swung with a rearward stroke in the direction of arrow 85. Engagement of drive surface 93 with a tooth 87 as lever 57 is swung in the rearward direction of arrow 85 rotates pinion gear 55 in the direction of arrow 85 cooperating with rack 51 to extend ram 47 from jack 10.

When lever 57 is swung in the forward direction of arrow 83, pin 91 rotates within yoke 79 against the spring (not shown) so that drive surface 93 rides over teeth 87 of pinion gear 55 such that movement of lever 57 does not power pinion gear 55 rotation. Forward movement of lever 57 in the direction of arrow 83 is useful to position lever 57 for a rearward stroke in the direction of arrow 85 to advance ram 47 and to position lever 57 for subsequent rearward strokes to further extend ram 47.

With drive surface 93 of clutch 89 pin 91 and pinion gear 55 engaged, a rearward stroke of lever 57 in the direction of arrow 85 causes pinion gear 55 to rotate in the direction of arrow 85. Rotation of pinion gear 55 on shaft 77 in the direction of arrow 85 with pinion gear 55 teeth 87 meshed with rack 51 teeth 95 drives rack 51 axially along base axis 45 to extend ram 47 axially outward from base 43 in the direction of forward arrow 83.

Referring further to FIGS. 1-3, 5, and 11-13, a ratchet mechanism 99 may be provided to control rotation of pinion gear 55 to advance ram 47 to apply and maintain force applied by jack 10 and to release the force. Application of force by jack 10 made possible by ratchet mechanism 99 also increases gripping force by securement mechanism 11 on support member 13 as described herein.

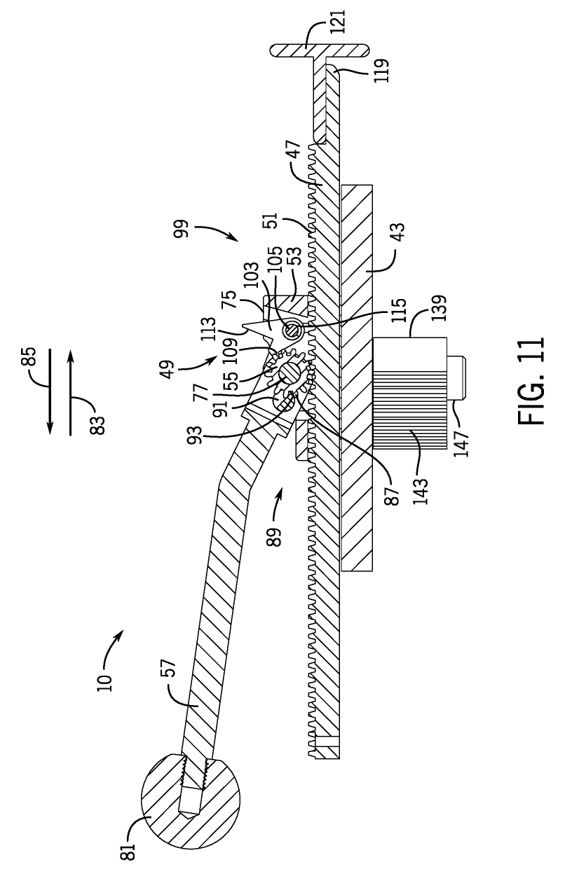

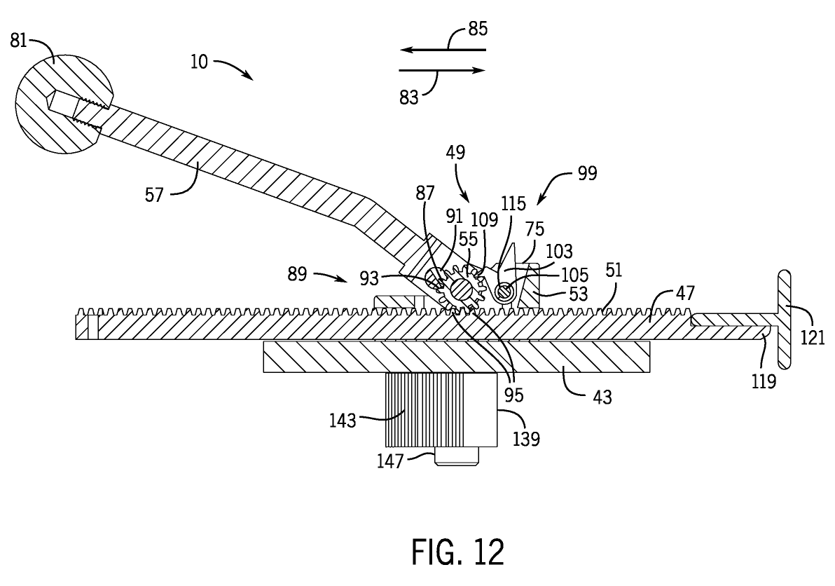

In embodiments, ratchet mechanism 99 may include a pair of anti-reversing pawls 101, 103 and pinion gear 55. Pawls 101, 103 may be pivotably secured with respect to gear housing 53 on a shaft 105 mounted between gear housing 53 sides 73, 75. Each pawl 101, 103 may be independently mounted on shaft 105 for pivotable movement alternatively in the forward and rearward direction of arrows 83, 85. Each pawl 101, 103 may include a tip 107, 109 and a release surface 111, 113. Tip 107 may be shorter than tip 109. A torsion spring (one shown as 115 in FIGS. 11-12) may be provided to bias each pawl 101, 103 tip 107, 109 toward contact with teeth 87 of pinion gear 55. The difference in the length of tips 107, 109 enables one pawl 101 or the other 103 to ride over a tooth 87 while the other pawl 101 or 103 is in contact with a tooth 87 to prevent reverse rotation of pinion gear 55. Pawl 101, 103 tips 107, 109 ride over pinion gear 55 teeth 87 when pinion gear 55 rotates in the rearward direction of arrow 85 during rearward movement of lever 57 resulting in ram 47 extension in the direction of arrow 83.

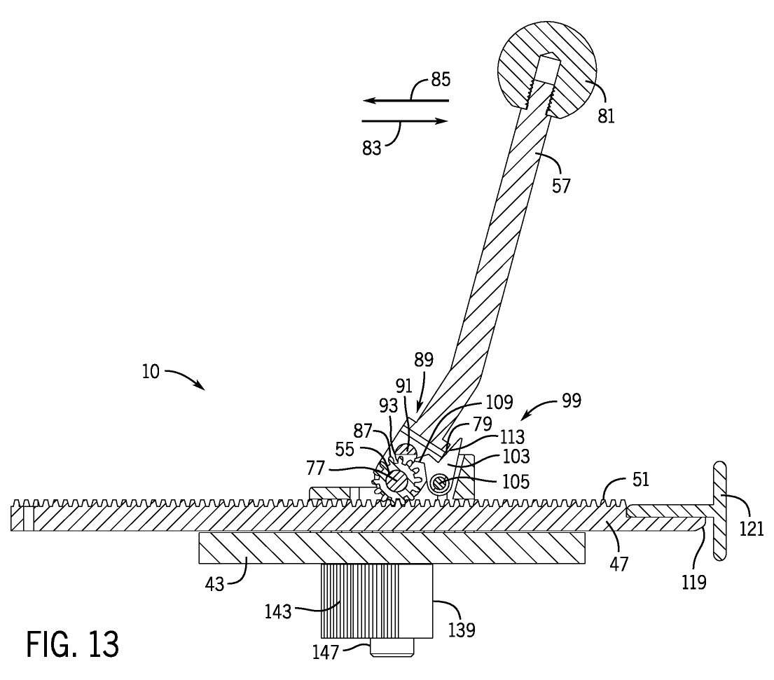

Ratchet mechanism 99 further serves to limit and stop reverse rotation of pinion gear 55 to apply and maintain force applied by jack 10. As illustrated in FIG. 13, alternating engagement of pawl 101, 103 tips 107, 109 with a tooth 87 of pinion gear 55 limits and stops reverse rotation of pinion gear 55 in the forward direction of arrow 83 to prevent retraction of ram 47 in the direction of rearward arrow 85, thereby maintaining force applied by ram 47 and jack 10 against a building component 17. Alternating contact between pawl 101 or 103 and tooth 87 provides for more precise control over reverse rotation of pinion gear 55 which, in turn, provides for more precise control over force applied by jack 10. In the embodiments, pawls 101, 103 further alternatingly prevent retraction of ram 47 while lever 57 is swung forward in the direction of arrow 83 (with one-way clutch 89 disengaged) toward base 43 first end 63 to a position ready for a further rearward stroke or strokes of lever 57 enabling ratcheting forward advancement of ram 47 in the direction of arrow 83.

Ratchet mechanism 99 further cooperates with ram-drive mechanism 49 to release force applied by jack 10. Referring to FIG. 13, ram 47 may be retracted in the direction of rearward direction of arrow 85 by release of pawl 101, 103 tips 107, 109 from pinion gear 55 tooth 87. Pawls 101, 103 may be released by forward pivoting movement of lever 57 in the direction of arrow 83 to bring yoke 79 into contact with both pawl releases 111, 113, thereby releasing contact between the pawl tip 107 or 109 which is in contact with a tooth 87 of pinion gear 55 and that tooth 87 enabling free rotation of pinion gear 55 in the forward direction of arrow 83. Rotation of pinion gear 55 in the direction of arrow 83 is possible because rotation of clutch pin 91 enables drive surface 93 to ride over pinion gear 55 teeth 87 during rotation of pinion gear 55 in the direction of arrow 83. Free rotation of pinion gear 55 in the direction of arrow 83 enables rack 51 and ram 47 to be easily retracted in the direction of arrow 85 along base axis 45 by release of the force applied by ram 47 or by user pushing. Pawls 101, 103 may also be released from pinion gear 55 by user pushing of pawl releases 111, 113 potentially with a tool.

As illustrated in FIGS. 1-6 and 11-15, ram 47 may include a distal end 119 with a pusher 121. In embodiments, pusher 121 may be a “T-shaped” element when viewed from the side. Ram 47 may be made of any rigid material, such as aluminum. Pusher 121 front surface 123 may push against a building component 17, such as planks 19, 21. Pusher 121 may have any suitable configuration and may even comprise just the distal end 119 of ram 47 itself. Optionally, pusher 121 could be modified to support attachments, such as a cushion or a fence (not shown), to facilitate use of jack 10 with articles that may be more fragile or where an increased pusher 121 front surface 123 area is desired.

Referring again to FIGS. 1-15, an example of a self-adjusting securement mechanism 11 will next be described. Securement mechanism 11 advantageously includes structure enabling rapid positioning and repositioning of jack 10 for use and also enables jack 10 to be supported on a support member 13 (e.g., joists 31, 33, 35) with a range of different thickness dimensions 15 or “T” without any need for manual adjustment of securement mechanism 11. These novel capabilities provide a jack 10 which is easier and more efficient to use than prior jacks which require securement using a linkage, or a lever, or even the user’s fingers.

Turning then to FIGS. 1-4 and 6-15, the example of securement mechanism 11 provides a type of clamp which applies a clamping or gripping force which secures jack 10 to a support member 13, such as the joists 31, 33, 35 illustrated in FIGS. 2-3, and 14-15. A clamp means or refers to a device designed to hold something firmly and a clamping force refers to a force which holds firmly. The clamping force secures jack 10 with respect to support member 13 so that a pushing force can be applied by jack 10. The clamping force applied by securement mechanism 11 can be quickly released to enable jack 10 to be removed from support member 13, or repositioned on support member 13, or moved to a different support member 13.

A support member 13 (e.g., joists 31, 33, 35) to which jack 10 may be secured by securement mechanism 11 may be made of a wood material or any material to which securement mechanism 11 can be securely clamped. By way of example only, support member 13 could be a conventional 2” x 6”, 2” x 8”, 2” x 10”, or 2” x 12” joist made of wood such as pine.

As illustrated in FIGS. 2-3 and 14-15, a support member 13 may have side surfaces 125, 127, edges 129, 131 (which may be top and bottom edges if the support member is stood on an edge 129, 131), and ends 133, 135. For convenience and brevity, identical reference numbers are used for the side, edge, and ends of each joist 31, 33, and 35. A thickness dimension 15 or “T” may be defined between side surfaces 125, 127, a width dimension “W” may be defined between edges 129, 131 and a length dimension “L” may be defined between ends 133, 135. In the example of joists 31, 33, 35, securement mechanism 11 grips side surfaces 125, 127 with second side 61 of base 43 supported on edge 129 when in an upright position as illustrated in FIGS. 2-3.

In the examples, securement mechanism 11 may comprise a pair of independently pivotable jaws 137, 139. Jaws 137, 139 may each have a gripping surface 141, 143 for contacting and gripping against side surfaces 125, 127 of support member 13 to thereby clamp and hold jack 10 in place against support member 13 for pushing by jack 10. Gripping surfaces 141, 143 may generally each face the other and face generally inward as described in more detail herein.

Each jaw 137, 139 may be eccentrically pivotably mounted along second side 61 of base 43 on a respective pivot axis 149, 151 which is located approximately equidistant from base axis 45. Jaws 137, 139 may independently swing bidirectionally, alternatively, in first and second directions to move gripping surfaces 141, 143 toward and, alternatively, away from the other. In the examples, each jaw 137, 139 is biased to pivot to swing each gripping surface 141, 143 toward the other. Jaws 137, 139 may pivot away from the other against the biasing force. Pivoting of gripping surfaces 141, 143 away from the other is helpful to spread jaws 137, 139 apart so as to fit a support member 13 therebetween when placing jack 10 on support member 13 in preparation for use of jack 10. Jaws 137, 139 swing gripping surfaces 141, 143 toward the other to thereby self-adjust to the thickness dimension 15 of a support member 13 positioned between jaws 137, 139 for purposes of firmly securing jack 10 to support member 13 as pushing force is applied by jack 10.

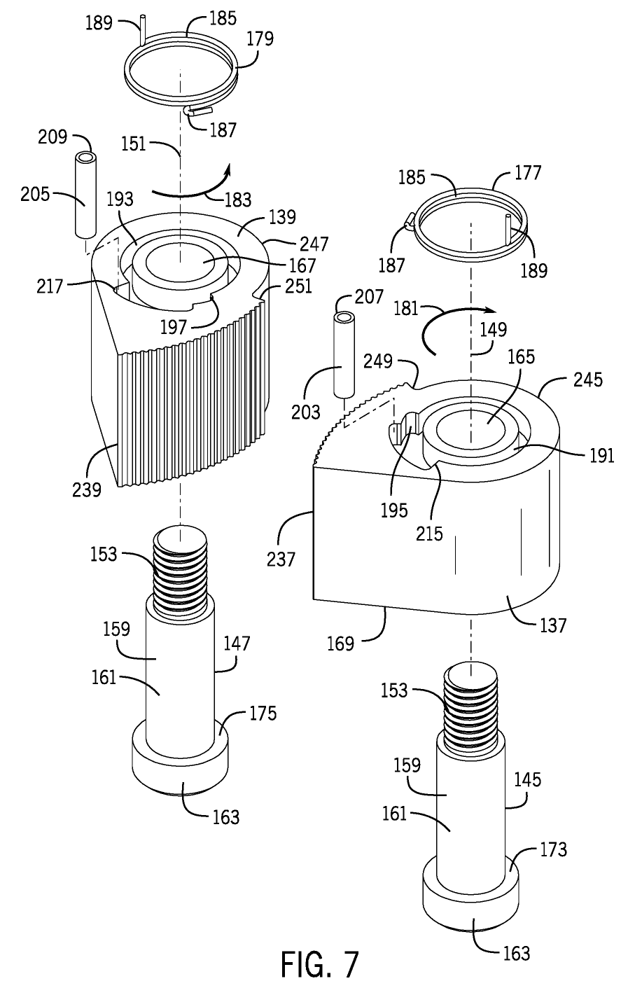

As illustrated in FIGS. 1-7 and 11-15, each jaw 137, 139 may be pivotably mounted to base 43 by means of a bolt 145, 147, or a like fastener. Each bolt 145, 147 provides a respective pivot axis 149, 151. Each bolt 145, 147 may include threads 153 sized to mesh with threaded openings 155, 157 in base 43. Each bolt 145, 147 may further include a shank 159 with an elongate cylindrical smooth outer surface 161 and a head 163. In the examples, each bolt 145, 147 is sized to fit within an elongate cylindrical smooth surface cylindrical bore 165, 167 of jaw 137, 139 so that each jaw 137, 139 can pivot or swing about respective pivot axis 149, 151 defined by each bolt 145, 147. Bearing surface 169, 171 of each jaw 137, 139 (FIGS. 7-9) rides against head 173, 175 of each bolt 145, 147 and head 173, 175 acts as a retainer which retains a respective jaw 137, 139 on second side 61 of base 43.

Referring to the exploded view of FIG. 7 and FIGS. 8-9, each jaw 137, 139 may be biased to pivot inwardly toward the other jaw 137 or 139 in the direction of arrows 181, 183 to pivot toward a clamping or gripping position against support member 13 enabling each jaw 137, 139 to contact and grip a side surface 125, 127 of support member 13 (e.g., a joist 31, 33, 35). As illustrated in FIG. 7, a torsion spring 177, 179 may be provided for each jaw 137, 139 to bias a respective jaw 137, 139 to pivot inwardly in the direction of arrows 181, 183.

Each torsion spring 177, 179 may include one or more coil 185 and first and second legs 187, 189. Each coil 185 may be seated in an annular portion of recess 191, 193, of a respective jaw 137, 139 with first leg 187 bearing against a notch 195, 197 of a respective jaw 137, 139 and second leg, 189 seated in an opening (not shown) in second side 61 of base 43. Torque exerted by torsion springs 177, 179 provides a force which biases each respective jaw 137, 139 to pivot inwardly in the respective directions of arrows 181, 183.

Referring to FIG. 7-9, stops 203, 205 may be provided to limit inward pivoting movement of respective jaws 137, 139 in the direction of arrows 181, 183. Each stop 203, 205 may be in the form of an axial pin located in recess 191, 193 with one end 207, 209 secured to second side 61 of base 43. Each stop 203, 205 may bear against stop surface 215, 217 of a respective jaw 137, 139 stopping inward pivoting movement of each jaw 137, 139 under the influence of a respective spring 177, 179.

In the examples, each jaw 137, 139 is capable of independent pivoting movement such that each jaw 137, 139 pivots independently of the other. No lever, linkage, or other mechanism is provided or necessary to interconnect jaws 137, 139 for coordinated pivoting movement. The independent pivoting movement of each jaw 137, 139 enables each jaw 137, 139 to automatically contact a side surface 125, 127 of support member 13 even if base axis 45 of jack 10 is somewhat misaligned with the support member on which base 43 of jack 10 is placed. Each jaw 137, 139 can pivot respectively toward the other in the direction of arrows 181, 183 and away from the other in respective directions opposite arrows 181, 183. Each jaw 137, 139 can pivot inwardly in the direction of arrows 181, 183 in an amount proportional to the thickness dimension 15 “T” of support member 13 when base axis 45 and support member are coaxially aligned. And, each jaw 137, 139 pivots toward the other until stopped by contact with support member 13 between jaws 137, 139 or by contact with stop 203, 205 if no support member 13 is between jaws 137, 139. Securement mechanism 11 does not rely on any offset relationship between ram 47 moving along axis 45 of base 43 and jaws 137, 139 to secure jack 10 to support member 13 because jaws 137, 139 cooperate for securement of jack 10 to support member 13.

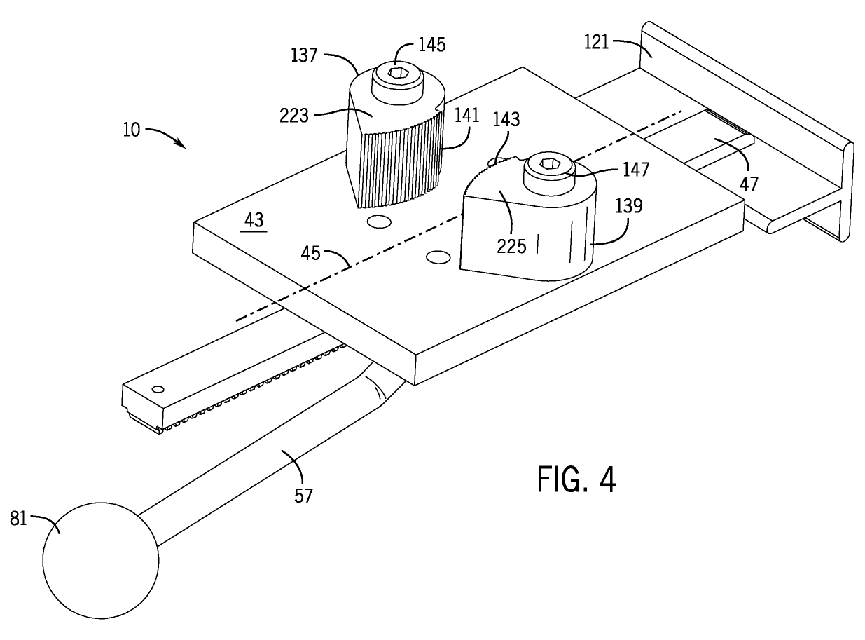

Referring next to FIGS. 4, 6-10, and 14-15, each jaw 137, 139 may be of a cam-type structure mounted eccentrically on a respective pivot axis 149, 151 provided by bolts 145, 147. In the examples, each jaw 137, 139 may be provided with a cam-like profile 219, 221 forming a lobe 223, 225 including gripping surfaces 141, 143, which may be curved. Gripping surfaces 141, 143 may generally face inward toward axis 45 and toward the other gripping surface 141, 143. Referring to the example of FIG. 10, it can be seen that radii 227, 229, 231 between a pivot axis 149, 151 and curved gripping surfaces 141, 143 increase in length from shorter radii (e.g., radius 227) located toward leading end 233, 235 of gripping surfaces 141, 143 to longer radii (e.g., radius 231) toward trailing end 237, 239 of gripping surfaces 141, 143. The lobe structure 223, 225 narrows spacing 241 between jaws 137, 139 as jaws 137, 139 pivot inwardly in the direction of arrows 181, 183 for purposes of gripping support member 13 between jaws 137, 139 as described herein. Differences in narrowing 241 of spacing between jaws 137, 139 responsive to differences in the thickness 15 dimension of support member 13 can be appreciated by comparing the spacing 241 in FIGS. 14 and 15. FIG. 14 shows narrower spacing 241 between jaws 137, 139 as compared with the relatively wider spacing 241 between jaws 137, 139 illustrated in FIG. 15.

A plurality of projections, which may be teeth 243, formed in gripping surfaces 141, 143 may be provided to improve gripping of jaws 137, 139 against wood and other types of compressible materials used for support member 13.

A curved leading surface 245, 247 may be provided on each jaw 137, 139 together with a protrusion 249, 251 at leading end 233, 235 of each gripping surface 141, 143 extending inwardly toward base axis 45. Curvature of each leading surface 245, 247 is useful to contact support member 13 for purposes of guiding jack 10 over support member 13 to place jack 10 atop edge 129 of support member 13. Contact between protrusion 249, 251 and side surface 125, 127 of support member 13 pivots jaws 137, 139 outwardly in the direction opposite arrows 181, 183 against force applied by springs 177, 179 until jack 10 is atop edge 129 of support member 13. Force applied by springs 177, 179 will pivot a respective jaw 137, 139 back inwardly in the direction of arrows 181, 183 until pivoting movement of each jaw 137, 139 is stopped by contact with a respective side surface 125, 127 of support member 13 with teeth 243 of facing gripping surfaces 141, 143 against a respective side surface 125, 127. Each jaw 137, 139 is capable of independent bidirectional pivoting movement, alternatively, in the direction of arrows 181, 183 and opposite arrows 181, 183.

A comparison of FIGS. 14 and 15 demonstrates examples of self-adjustment by jaws 137, 139 to joists 33, 35 of different thickness dimensions 15 or “T”. It can be seen that joist 33 support member 13 of FIG. 14 has a relatively narrower thickness dimension 15 than that the joist 35 support member 13 of FIG. 15. Because joist 33 is narrower than joist 35, jaws 137, 139 of FIG. 14 pivot inwardly in the direction of arrows 181, 183 a relatively greater amount than jaws 137, 139 of FIG. 15. The spacing between jaws 137, 139 is less in the example of FIG. 14 than in FIG. 15 because of the relatively greater pivoting movement demonstrated in FIG. 15. Jaws 137, 139 move proportionally in relationship to the thickness dimension 15 of joists 33, 35 when axis 45 of base 43 and support member 13 are coaxially aligned. The difference in pivoting movement of jaws 137, 139 represented in the examples of FIGS. 14-15 exemplifies self-adjustment of securement mechanism 11 to support members 13 of different thicknesses.

Operation of lever 57 and ram-drive mechanism 49 both applies force and causes securement mechanism 11 to clamp jack 10 to support member 13. Rearward movement of lever 57 in the direction of arrow 85 operates ram-drive mechanism 49 to extend ram 47 and pusher 121 against building component 17 or another object. As force applied by jack 10 increases, base 43 moves away from building component 17 in the rearward direction of arrow 85. Rearward movement of base 43 in the direction of arrow 85 with teeth 243 of gripping surfaces 141, 143 against side surfaces 125, 127 causes jaws 137, 139 to further pivot inwardly in the direction of arrows 181, 183 reducing the spacing 241 between gripping surfaces 141, 143 of jaws 137, 139 and clamping jack 10 to support member 13 as teeth 243 bite into support member 13. The force applied by jaws 137, 139 against support member 13 increases as the pushing force applied by ram 47 increases during movement of lever 57 in the direction of arrow 85 which is useful to firmly hold jack 10 in place on support member 13. As explained previously, co-action of pawls 101 or 103 with pinion gear 55 maintains the force of ram 47 against building component 17.

Further operation of lever 57 and ram-drive mechanism 49 both withdraws the force applied by jack 10 and breaks the clamping force of securement mechanism 11 to enable repositioning of jack 10. Forward movement of lever 57 in the direction of arrow 83 brings yoke 79 into contact with pawl releases 111, 113 causing pawls 101 or 103 to disengage pawl tips 107 or 109 from pinion gear 55. Disengagement of pawls 101 or 103 from pinion gear 55 with ram 47 under load causes base 43 to momentarily move in the forward direction of arrow 83. Forward movement of base 43 in the direction of arrow 83 may be quite small. The momentary forward movement of base 43 in the direction of arrow 83 is sufficient to cause jaws 137, 139 to pivot rearwardly in the direction opposite arrows 181, 183 enough to release the clamping effect of jaws 137, 139 from side surfaces 125, 127 of support member 13, enabling jack 10 to be repositioned by sliding movement on support member 13 or to simply be picked up by the user with the user’s hand and removed from support member 13 altogether. Ram 47 may also be retracted by user pushing of pusher 121 with pawls 101 or 103 disengaged from pinion gear 55.

Jack 10 may be used with any support member 13 capable of fitting between jaws 137, 139. In embodiments, the spacing between pivot axes 149, 151 of jaws 137, 139 can be narrowed or widened by changing the spacing between threaded openings 155, 157 on base 43. Multiple threaded openings, such as threaded openings 155, 157 with selected different spacing therebetween may be provided in base 43 for mounting of bolts 145, 147 which secure jaws 137, 139 to base 43 to provide for use of jack 10 with an even greater range of support members 13 with different thickness dimensions 15.

Operation of the example of jack 10 will now be described with respect to FIGS. 1-15. As already described, jack 10 may be used to apply a pushing force against many different types of building components 17, such as planks 19, 21, for purposes such as positioning or straightening of one or more building component 17. In an example of horizontal pushing, jack 10 may first be placed atop edge 129 of support member 13 with base 43 of jack 10 resting on edge 129 so that jack 10 is supported on support member 13 with axis 45 of base 43 generally axially aligned with length dimension “L” of support member 13.

As jack 10 is positioned atop support member 13, contact between curved leading surfaces 245, 247 and protrusions 249, 251 of jaws 137, 139 with side surfaces 125, 127 of support member 13 spreads jaws 137, 139 outwardly against springs 177, 179 in the directions opposite arrows 181, 183. Once base 43 of jack 10 is atop support member 13, jaws 137, 139 pivot forward in the direction of arrows 181, 183 under the influence of springs 177, 179 until further pivoting movement of jaws 137, 139 is stopped by contact between gripping surfaces 141, 143 and teeth 243 with side surfaces 125, 127. If base 43 axis 45 is coaxial with support member 13, then jaws 137, 139 will move independently in identical angular amounts proportional to the thickness dimension 15 of support member 13. The independent pivoting movement of each jaw 137, 139 further enables each jaw 137, 139 to potentially pivot in different angular amounts should axis 45 of base 43 be offset toward one side surface 125 or the other side surface 127 of support member 13. The automatic pivoting of jaws 137, 139 means that the user’s hand, which is not holding jack 10, is free and is not required to position jaws 137, 139 against support member 13, either by touching jaws 137, 139 or through use of a lever or linkage of some sort.

Referring again to FIGS. 1-15, with base 43 of jack 10 atop support member 13, ram 47 may be extended with pusher 121 against building component 17 by user sliding of ram 47 and/or by use of lever 57. Movement of lever 57 rearward in the direction of arrow 85 causes ram-drive mechanism 49 to extend ram 47 from base 43 along base axis 45 by means of the rack-and-pinion provided by rack 51 and pinion gear 55. Extension of ram 47 and pusher 121 in the direction of arrow 83 against building component 17 causes base 43 to move rearwardly in the direction of arrow 85. Because gripping surfaces 141, 143 of jaws 137, 139 are automatically urged to press against respective side surfaces 125, 127 of support member 13 by springs 177, 179, rearward movement of base 43 causes jaws 137, 139 to pivot further inward in the direction of arrows 181, 183. This pivoting movement of jaws 137, 139 in turn presses teeth 243 of gripping surfaces 141, 143 hard against side surfaces 125, 127 of support member 13. Teeth 243 will bite into wood-type support members 13 as the distance between gripping surfaces 141, 143 diminishes due to the cam-type structure of jaws 137, 139 and the curvature of gripping surfaces 141, 143. Jaws 137, 139 of securement mechanism 11 continue to clamp and hold jack 10 against support member 13 while jack 10 applies force.

With base 43 and jack 10 held in place on support member 13 by securement mechanism 11, the force applied by ram 47 pushes building component 17 into the desired position as illustrated in FIG. 3. Building component 17 may then be set in place on support member 13 with an appropriate fastener, such as hidden fastener 37 and screw 39.

To remove the pushing force applied by jack 10, lever 57 is swung forward in the direction of arrow 83 contacting yoke 79 against pawl release surfaces 111, 113. Pivoting movement of pawl tip 107 or 109 out of contact with pinion gear 55 tooth 87 releases force applied by jack 10 as pinion gear 55 free rotation allows rack 51 and ram 47 to spring away from building component 17. The energy released causes base 43 and jack to momentarily move forward in the direction of arrow 83 pivoting jaws 137, 139 opposite arrows 181, 183 releasing the grip of jaws 137, 139 from support member 13. Jack 10 may then be repositioned on support member 13 for another pushing cycle or may be moved to a different location. Lever 57 and knob 81 provide convenient gripping points for holding of jack 10 with the user’s hand during repositioning.

Jack 10 may be used in orientations with a support member 13 other than the horizontal position illustrated in FIGS. 2-3. For example, jack 10 could be secured to a vertical wall stud to push against a wall panel (not shown). Jack 10 could be used in any application where securement mechanism 11 can be clamped against a support member 13 to hold jack 10 for applying a force.

Jack 10 may be constructed of any type of suitable material. For example, aluminum is an ideal material for use as base 43, ram 47, gear housing 53 and jaws 137, 139 because such material is lightweight and strong.

It will be apparent from the foregoing description that jack 10 has numerous advantages. Jack 10 is capable of applying a powerful pushing force. Jack 10 can be secured to support members 13 having a range of thickness dimensions 15. The pivoting jaws 137, 139 of securement mechanism 11 self-adjust to thickness dimension 15 of support member 13 without any need for levers, mechanical linkages, or manipulation with the user’s fingers, leaving the user’s free hand available to efficiently and quickly position jack 10. Securement mechanism 11 enables quick desecurement of jack 10 from support member 13 for rapid repositioning which is important in the construction trade where saving time increases profitability. Jack 10 can be used in any orientation in which securement mechanism 11 clamps to a support member 13. These and other features of jack 10 make installation of flooring elements, such as planks 19, 21 and other building components 17, better, cheaper, and faster.

* * *

While the principles of this invention have been described in connection with specific embodiments, it should be understood clearly that these descriptions are made only by way of example and are not intended to limit the scope of the invention.

What is claimed is:

1. A jack with a self-adjusting securement mechanism which automatically adjusts to a thickness dimension of a support member and which secures the jack to the support member as force is applied by the jack, the jack comprising:
. a base having first and second sides and a length defining an axis;
. a ram extendable from the first side of the base along the base axis;
. a ram-drive mechanism in power-transmission relationship with the ram operative to extend the ram to apply a pushing force; and
. a securement mechanism which clamps the jack to a support member, the securement mechanism having a pair of independently pivotable jaws
with generally facing gripping surfaces, each jaw being eccentrically pivotable mounted along the second side of the base on a pivot axis
approximately equidistant from the base axis and being biased to pivot so as to swing each gripping surface toward the other, thereby self-adjusting
the jaws to the thickness of a support member when between the jaws and clamping the jack to the support member as the pushing
force is applied by the jack.

2. The jack of claim 1 wherein each jaw pivots bidirectionally in first and, alternatively,
second directions to swing the gripping surfaces toward or away from the other.

3. The jack of claim 2 wherein each jaw pivots the gripping surface toward the other until
stopped by contact with a support member therebetween.

4. The jack of claim 3 wherein each jaw is a cam.

5. The jack of claim 3 wherein each jaw is biased to pivot by a spring.

6. The jack of claim 5 wherein the spring is a torsion spring.

7. The jack of claim 2 wherein each gripping surface is curved.

8. The jack of claim 7 wherein each gripping surface includes a plurality of projections.

9. The jack of claim 8 wherein the projections are teeth.

10. The jack of claim 8 wherein a clamping force applied by the jaws to the support member
increases as the pushing force applied by the jack increases.

11. The jack of claim 8 wherein the ram comprises:
. a bar having a distal end; and
. a pusher attached to the hair distal end.

12. The jack of claim 11 wherein the ram-drive mechanism comprises:
. a rack along the bar;
. a pinion gear meshed with the rack;
. a lever which powers pinion gear rotation; and
. a one-way clutch which enables the lever to power pinion gear rotation in one direction to
extend the ram.

13. The jack of claim 12 wherein operation of the lever in a first direction powers extension
of the ram and operation of the lever fully in a second direction releases the jaws from the support member.

14. The jack of claim 13 wherein the ram-drive mechanism further comprises:
. a pawl which allows pinion gear rotation in a first direction to extend the ram and which
engages the pinion gear to limit rotation in a second direction to maintain the force: and
. a surface associated with the lever which contacts and releases the pawl from the pinion
gear.
whereby, release of the pawl with the ram applying force causes the base to move sufficiently to
release the jaws from the support member.
